(19) United States
(12) Patent Application Publication
(10) Pub. No.: US 2010/0220085 A1
(43) Pub. Date: Sep. 2, 2010

(54) DISPLAY CONTROLLING SYSTEM AND METHOD THEREOF

(76) Inventor: Cheng-Chi Yen, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/395,718

(22) Filed: Mar. 2, 2009

(51) Int. Cl. G09G 5/00

(52) U.S. Cl. 345/211

(57) ABSTRACT

A display controlling system, which includes: a memory module, for buffering a pixel data; a comparator, for comparing the pixel data and a counter signal to generate a comparing result signal; and a pixel, for refreshing according to the comparing result signal.

### BACKGROUND OF THE INVENTION

1. Field of the Invention

The present invention relates to a display controlling system and a method thereof, and particularly relates to a display controlling system that can adjust displaying frame rate without a frame rate converter and a method thereof.

2. Description of the Prior Art

FIG. 1 is a schematic diagram illustrating a prior art display controlling system 100. As shown in FIG.1, the display controlling system 100 includes a pixel array 101 with a plurality of pixels, a data channel controller 103, a scan channel controller 105 and a timing controller 107. The timing controller 107 receives a serial data Dataₛ and a data enable signal DE to generate a data control signal D_{ctrl} and a scan control signal S_{ctrl} for respectively controlling the data channel controller 103 and the scan channel controller 105. The data channel controller 103 transfers the serial data Dataₛ to parallel data and transmits the parallel data to data lines 109 (only one of the data lines is marked by the numeral 109). Also, the scan channel controller 105 generates control signals to latch data in the pixels (for example, latch data to a memory of the pixel), via the scan lines 111 (only one of the scan lines is marked by the numeral 111).

However, the pixels shown in FIG. 1 always have no refreshing abilities. Therefore if higher displaying frame rate is needed, a frame rate converter must be added to speed up frame transmission speed to a panel, such that a lower data frame rate can be transferred to a higher displaying frame rate, but more cost and circuit areas are needed due to the existence of the frame rate converter.

### SUMMARY OF THE INVENTION

One objective of the present invention is providing a display controlling system that can control displaying frame rate without a frame rate converter, and a related method.

One embodiment of the present invention discloses a display controlling system, which includes: a memory module, for buffering a pixel data; a comparator, for comparing the pixel data and a counter signal to generate a comparing result signal; and a pixel, for refreshing according to the comparing result signal.

Another embodiment of the present invention discloses a display controlling method, which includes: buffering a pixel data; comparing the pixel data and a counter signal to generate a comparing result signal; and refreshing a pixel according to the comparing result signal.

Another embodiment of the present invention discloses a display controlling system, which includes: a plurality of memory modules, for buffering different types of pixel data; a selector, for selecting one of memory modules as a target memory module; and a comparator, for comparing pixel data from the target memory module and a counter signal to generate a comparing result signal; a pixel, for refreshing according to the comparing result signal.

Still another embodiment of the present invention discloses a display controlling method, which includes: buffering different types of pixel data in a plurality of memory modules; selecting one of memory modules as a target memory module; comparing pixel data from the target memory module and a counter signal to generate a comparing result signal; and refreshing a pixel according to the comparing result signal.

According to above mentioned description, the displaying frame rate can be controlled without utilizing a frame rate converter, thus the cost and circuit region can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a prior art display controlling system.

FIG. 2 is a circuit diagram illustrating a display controlling system according to an embodiment of the present invention.

FIG. 3 is a circuit diagram illustrating a detail structure of a display controlling system according to an embodiment of the present invention.

FIG. 4 is a schematic diagram illustrating the operation of the display controlling system shown in FIG. 3.

FIG. 5 is a circuit diagram illustrating a display controlling system according to another embodiment of the present invention.

FIG. 6 is a schematic diagram illustrating the operation of the display controlling system shown in FIG. 5.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

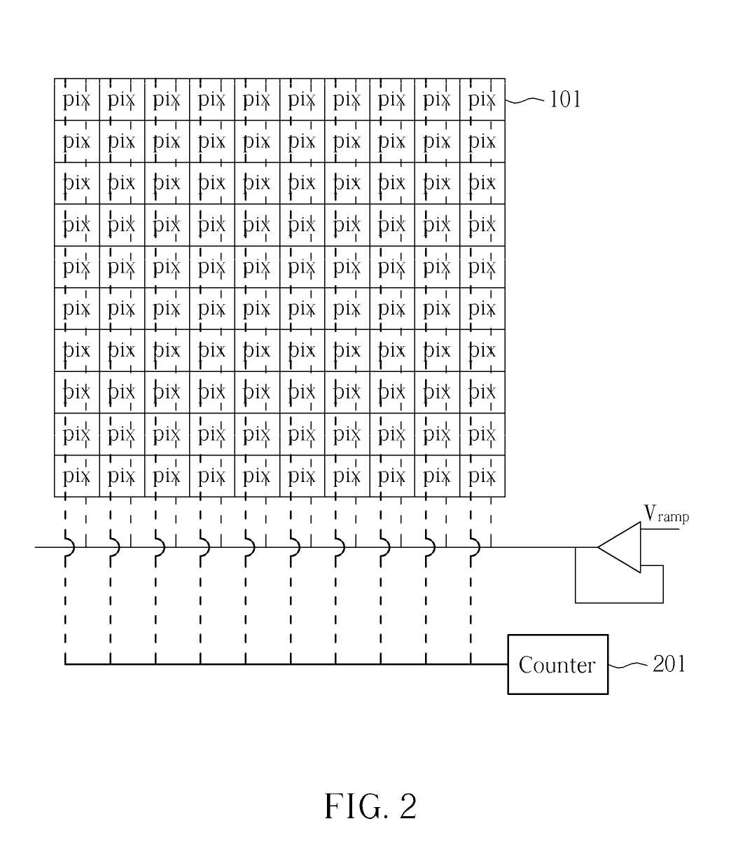

FIG. 2 is a circuit diagram illustrating a display controlling system according to an embodiment of the present invention. As shown in FIG. 2, a ramp voltage Vᵣₐₘₚ is provided to the pixels in the pixel array 101, and a counter 201 is also provided to count the ramp voltage Vᵣₐₘₚ. The counter 201 counts the ramp voltage Vᵣₐₘₚ to generate a count value, and the pixels in the pixel array 101 are refreshed if the count value reaches some specific rules, which will be described below.

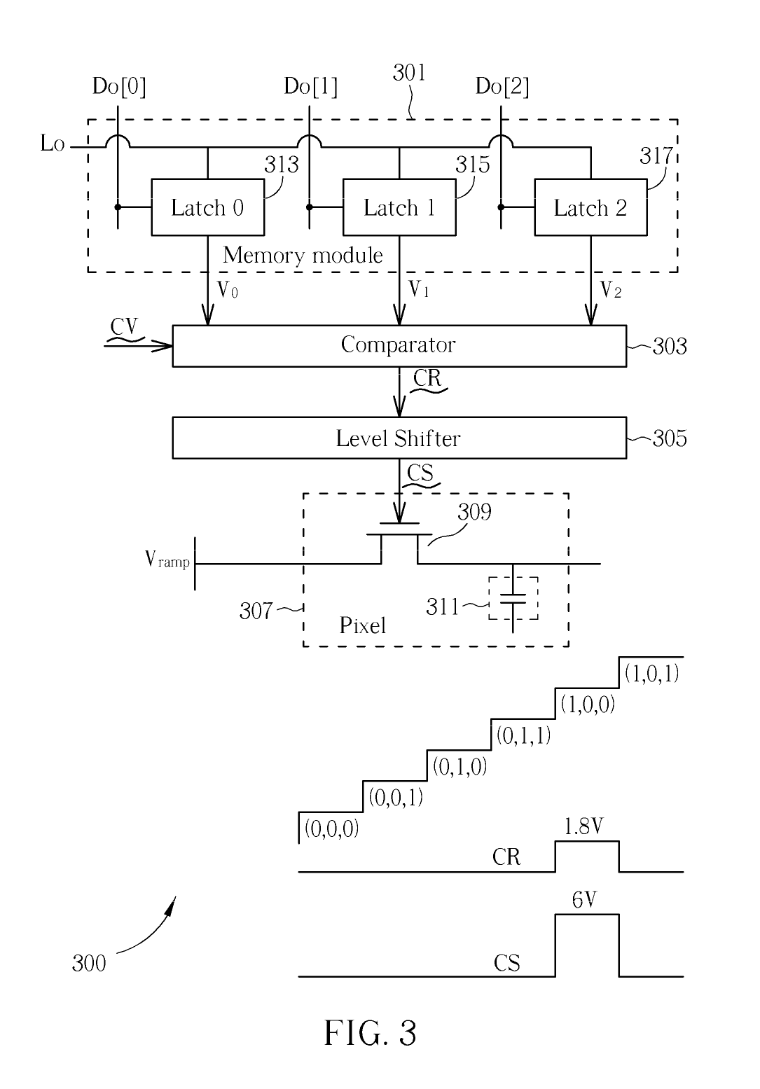

FIG. 3 is a circuit diagram illustrating a detail structure of a display controlling system 300 according to an embodiment of the present invention. As shown in FIG. 3, the display controlling system 300 includes a memory module 301, a comparator 303, a level shifter 305 and a pixel 307. The memory module 301 buffers a pixel data. The comparator 303 compares the pixel data and a counter signal CV to generate a comparing result signal CR. The pixel 307 refreshes according to the comparing result signal CR.

In this embodiment, the pixel 307 is a 3-bit pixel, and the memory module 301 includes 3 latches 313, 315 and 317 to latch the pixel data D₀[0], D₀[1] and D₀[2] (i.e., the grey level), which are [1, 0, 0] in this case. Please note that the pixel applied to the embodiments of the present application is not limited to 3 bit. For example, the pixel can be a N-bit pixel, and N is a positive integer. Accordingly, if the counter signal CV reaches the value [1, 0, 0], the comparator 303 will generate a comparing result signal CR with a high voltage level. The meaning of the counter signal CV will be described as below. The level shifter 305 shifts a voltage level of the comparing result signal CR to generate a control signal CS to control the pixel 307 to refresh or not. For example, the voltage level of the comparing result signal CR, which is 1.8V in this embodiment, is shifted to the voltage level of the control signal CS, which is 6V in this embodiment. The control signal CS is utilized to turn on or turn off the switch 309 in the pixel 307, and the capacitor 311 is charged by the ramp voltage Vᵣₐₘₚ when the control signal CS turns on the switch 309. That is, when the control signal CS turns on the switch 309, the ramp voltage Vᵣₐₘₚ is transmitted to the pixel 307 such that the pixel 307 refreshes. The transmitted ramp voltage Vᵣₐₘₚ corresponds to the latched pixel data (i.e., the grey level) of the pixel 307. Specifically, the ramp voltage Vᵣₐₘₚ indicates grey level voltages. The counter value CV indicates the grey level and the ramp voltage Vᵣₐₘₚ varies following the counting of the counter.

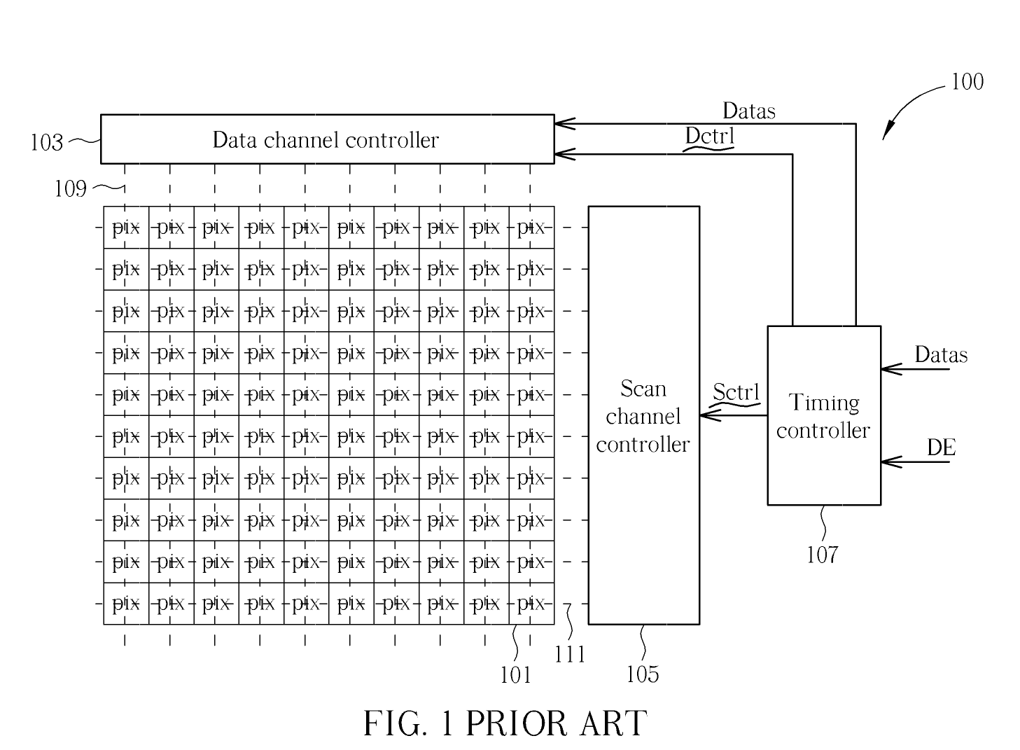

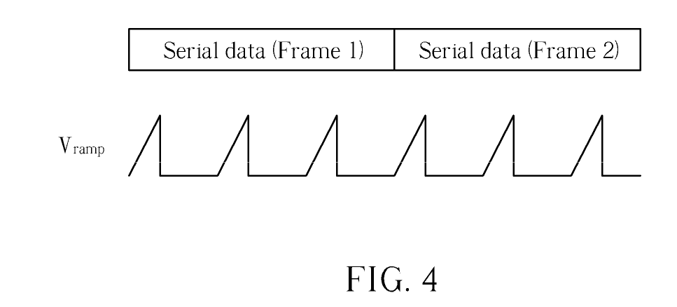

The displaying frame rate can be controlled via utilizing the ramp voltage Vᵣₐₘₚ to refresh the pixel 307 or not, therefore the frame rate converter described in FIG. 1 can be omitted. FIG. 4 is a schematic diagram illustrating the operation of the display controlling system shown in FIG. 3. As shown in FIG. 4, the pixels are refreshed three times in a time period of a frame, thus the displaying frame rate is three times of the data frame rate. Besides, the increasing operation of the ramp voltage Vᵣₐₘₚ and the operation of the counter are independent from the accessing operation for the pixels, thus the displaying frame rate can be randomly adjusted.

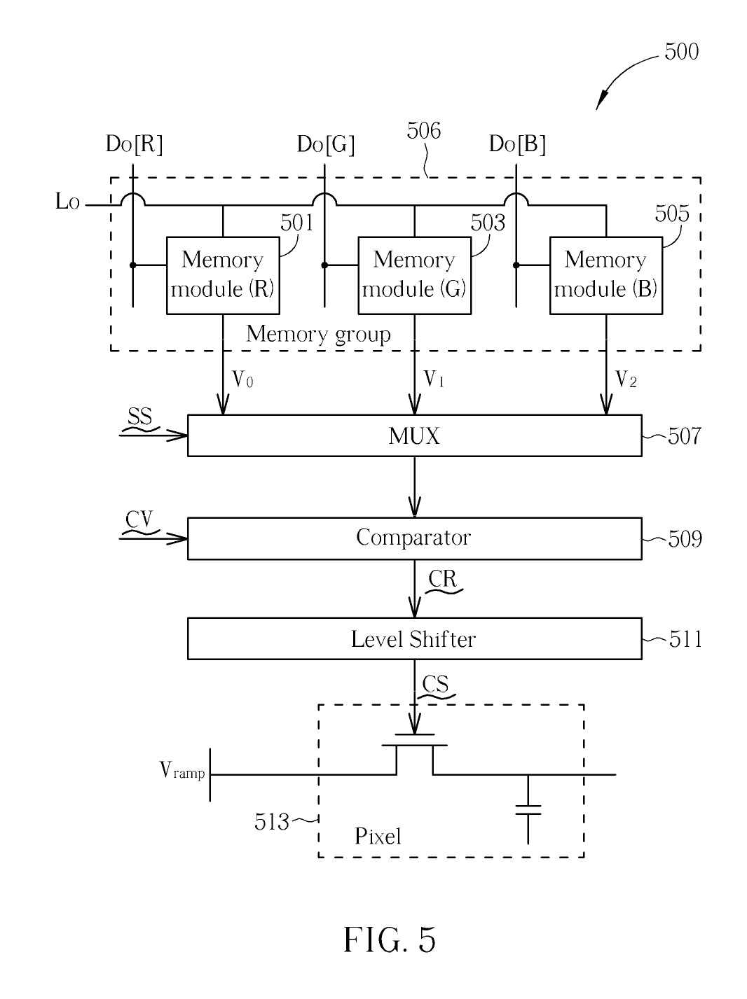

FIG. 5 is a circuit diagram illustrating a display controlling system 500 according to another embodiment of the present invention. In this embodiment, several memory modules 501, 503 and 505 are included in a memory group 506. The memory modules 501, 503 and 505 are arranged to buffer different types of pixel data. In this embodiment, the memory modules 501, 503 and 505 respectively buffer Red pixel data, Green pixel data, and Blue pixel data. The multiplexer (selector) 507 is arranged to select one of memory modules 501, 503 and 505 as a target memory module. The comparator 509 is arranged to compare pixel data from the target memory module and a counter signal CV to generate a comparing result signal CR. The pixel 513 is refreshed according to the comparing result signal CR.

Similar with the display controlling system 300 shown in FIG. 3, the display controlling system 500 also includes a level shifter 511. The level shifter 511 shifts a voltage level of the comparing result signal CR to generate a control signal CS to control the pixel 513 to refresh or not. Once the target memory module is determined, the operation of the display controlling system 500 is similar with the display controlling system 300, thus it is omitted for brevity.

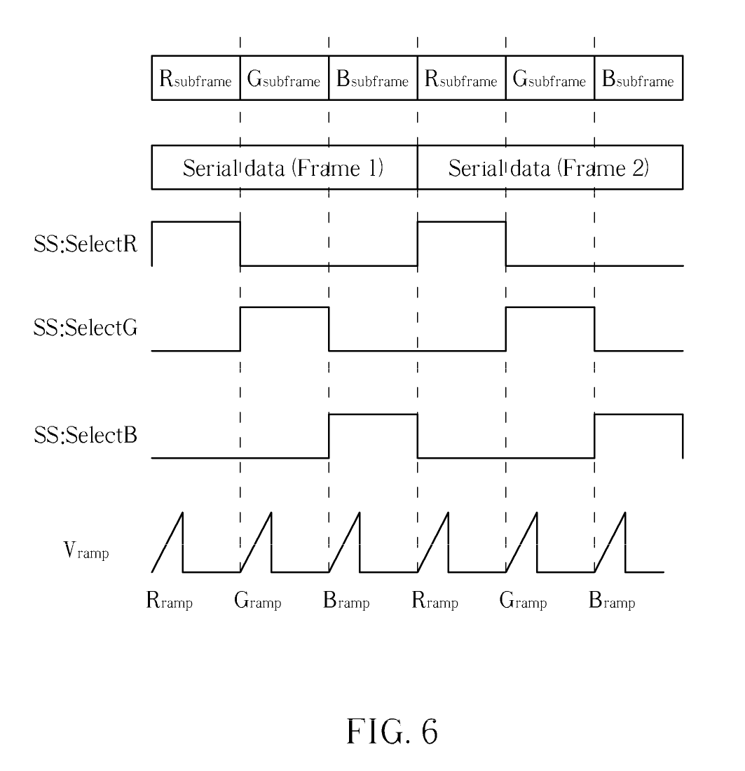

FIG. 6 is a schematic diagram illustrating the operation of the display controlling system shown in FIG. 5. As shown in FIG. 6, frame 1 and frame 2 respectively include R subframe, G subframe and B subframe, and the selection signal SS respectively select the memory modules 501, 503 and 505 as the target memory module corresponding to which subframe is processed. Vᵣₐₘₚ is utilized to refresh the pixel, as above mentioned. Therefore, the displaying frame rate can be well controlled, no matter which subframe is processed.

It should be noted that the above-mentioned description are only for example and do not mean to limit the scope of the present invention. For example, the pixel is not limited to a 3-bit pixel and the number of latches shown in FIG. 3 is not limited to 3. Besides, the comparing result signal CR can be a signal having enough voltage level to turn on the switch 309, thus the level shifter 305 and 511 can be omitted. Additionally, the number of memory modules shown in FIG. 5 is not limited to 3, and the memory modules shown in FIG. 5 is not limited to store R pixel data, G pixel data, and B pixel data.

According to above mentioned description, the displaying frame rate can be controlled without utilizing a frame rate converter, thus the cost and circuit region can be reduced.

Those skilled in the art will readily observe that numerous modifications and alterations of the device and method may be made while retaining the teachings of the invention.

What is claimed is:

1. A display controlling system, comprising:
a memory module, for buffering a pixel data;
a comparator, for comparing the pixel data and a counter signal to generate a comparing result signal; and
a pixel, for refreshing according to the comparing result signal.

2. The display controlling system of claim 1, further comprising a level shifter for shifting a voltage level of the comparing result signal to generate a control signal to control the pixel to refresh or not.

3. The display controlling system of claim 1, wherein the pixel includes a capacitor and the voltage across the capacitor is refreshed according to the comparing result signal.

4. The display controlling system of claim 1, wherein the pixel is refreshed when the comparing result signal indicates that the pixel data and the counter signal have the same values.

5. The display controlling system of claim 1, wherein the pixel is an N bit pixel and the memory module includes N latches, where N is a positive integer.

6. The display controlling system of claim 1, wherein the pixel refreshes via a grey level voltage, where the counter signal indicates the grey level voltage.

7. A display controlling system, comprising:
a plurality of memory modules, for buffering different types of pixel data;
a selector, for selecting one of memory modules as a target memory module; and
a comparator, for comparing pixel data from the target memory module and a counter signal to generate a comparing result signal;
a pixel, for refreshing according to the comparing result signal.

8. The display controlling system of claim 7, wherein pixel is refreshed when the comparing result signal indicates that the pixel data and the counter signal have the same values.

9. The display controlling system of claim 7, wherein the pixel is an N bit pixel, and each one of the memory module includes N latches, where N is a positive integer.

10. The display controlling system of claim 7, wherein the memory modules respectively store Red pixel data, Green pixel data and Blue pixel data.

11. The display controlling system of claim 7, wherein the pixel refreshes via a grey level voltage, where the counter signal indicates the grey level voltage.

12. A display controlling method, comprising:
buffering a pixel data;
comparing the pixel data and a counter signal to generate a comparing result signal; and
refreshing a pixel according to the comparing result signal.

13. The display controlling method of claim 12, further comprising shifting the comparing result signal to generate a control signal to control the pixel to refresh or not.

14. The display controlling method of claim 12, wherein the pixel is refreshed when the comparing result signal indicates that the pixel data and the counter signal have the same values.

15. The display controlling method of claim 12, wherein the pixel is an N bit pixel and the memory module includes N latches, where N is a positive integer.

16. The display controlling method of claim 12, wherein the pixel is refreshed via a grey level voltage, where the counter signal indicates the grey level voltage.

17. A display controlling method, comprising:
buffering different types of pixel data in a plurality of memory modules;
selecting one of memory modules as a target memory module;
comparing pixel data from the target memory module and a counter signal to generate a comparing result signal; and
refreshing a pixel according to the comparing result signal.

18. The display controlling method of claim 17, further comprising shifting a voltage level of the comparing result signal to generate a control signal to control the pixel to refresh or not.

19. The display controlling method of claim 17, wherein the pixel is refreshed when the comparing result signal indicates that the pixel data and the counter signal have the same values.

20. The display controlling method of claim 17, wherein the pixel is refreshed via a grey level voltage, where the counter signal indicates the grey level voltage.
